(19) United States
(12) Patent Application Publication
(10) Pub. No.: US 2021/0339122 A1
(43) Pub. Date: Nov. 4, 2021

(54) Systems and Methods for Utilizing Multiple Mapping Schemes in a Virtual Reality Environment

(71) Applicant: MassVR, LLC, Skoki, IL (US)

(72) Inventor: Roberto Ritger, Evanston, IL (US)

(21) Appl. No.: 17/307,710

(22) Filed: May 4, 2021

Related U.S. Application Data
(60) Provisional application No. 63/019,958, filed on May 4, 2020.

(51) Int. Cl. A63F 13/216; A63F 13/428

(52) U.S. Cl. CPC A63F 13/216; A63F 2300/8082; A63F 13/428

(57) ABSTRACT

Systems and methods for presenting a virtual reality environment to first and second users include a first user virtual reality device associated with a first mapping scheme, a second user virtual reality device associated with a second mapping scheme, a user location tracking system, a processor in communication with the first and second user virtual reality devices and the user location tracking system, and a memory. The processor is configured to: present the virtual reality environment to the first and second users; track movement of the first virtual reality device within the physical environment; present movement of the first user in the virtual reality environment according to the first mapping scheme; track movement of the second virtual reality device within the physical environment; and present movement of the second user in the virtual reality environment according to the second mapping scheme.

### CROSS-REFERENCE TO PRIOR FILED APPLICATIONS

This application incorporates by reference and claims the benefit of priority to U.S. Provisional Application No. 63/019,958 filed on May 4, 2020.

### BACKGROUND OF THE INVENTION

The present subject matter relates generally to systems and methods for generating a virtual reality environment that utilizes a plurality of mapping schemes. More specifically, the present subject matter relates generally to systems and methods for providing a virtual reality environment in which first and second users' relative movement in the physical space is different than the first and second users' relative movement in the in the virtual space.

Virtual reality (VR) systems are digitally-rendered environments in which users immerse themselves in a virtual experience. These environments can be modeled after real or imaginary locations. Current technology allows users to explore these environments using head-mounted displays (HMDs), often in conjunction with other equipment such as handheld controllers or movement-tracking clothing. HMDs display a virtual environment in front of the user's eyes. The HMDs can take a variety of forms, such as glasses, goggles, helmets, etc.

Some systems allow users to explore the virtual world by moving through their physical environment, such movement corresponding to and controlling movement in the virtual world. These real and virtual movements are usually limited in scope and range by the environment in which the user is physically located and by the virtual environment the user is exploring. While a user is immersed in a virtual reality system, the user's HMD typically prevents the user from seeing his or her physical surroundings; this is a tautological requirement of an immersive virtual experience.

VR environments are constructed to match or be based on a model of the physical environment in which the user is located when interacting with the VR environment (dimensions, elevations, etc.). The physical environment is preferably a large, open space in which users move easily and without interference. The design of the VR environment reflects the physical obstructions within the physical environment, including the outer perimeter of the space, any structural support members such as columns, walls, or doorways.

One of the problems that VR systems face is that a large amount of physical space is needed to accommodate a group of users in a virtual reality environment. The addition of users to the physical space limits the ability of users to move freely and increases the chances of collision. However, the nature of virtual reality allows for creative solutions to such physical limitations. VR environments can be displayed to users in shapes and configurations that do not match identically to the users' physical environment.

For example, VR environments can be displayed to users such that a user may appear to be changing in elevational space even when not moving vertically in the physical space. For example, a user may take an elevator (or escalator, ramp, zipline, etc.) to a virtual second level in the VR environment when the user's elevational position has not changed at all in the physical space. Similarly, the VR environment may display a change in elevation to a user that is riding in a hot air balloon even when the user's elevational position has not changed at all in the physical space. Accordingly, VR environments can be provided in which users occupy distinctly different elevational levels in the VR environment while occupying a singular elevational space in the physical environment. As such, there may be instances in which users appear in the VR environment in locations that do not correspond one to one with their locations in the physical space. However, such virtual offsets are limited in nominally expanding the virtual reality environment in only one direction.

Another major obstacle that VR systems face is preventing collisions in multi-user environments. Avatars, or virtual representations of users, are often used within a virtual environment to represent users to each other. For example, if I am interacting with a virtual environment along with two other users, the two other users may appear within my view of the virtual environment as computer generated avatars. Avatars are a straight-forward solution to virtual environments that are limited in scope and scale as a 1:1 ratio with the corresponding physical environment—a user's avatar can be accurately displayed in the user's actual location and appropriate visual cues will be provided to avoid collisions.

Accordingly, there is a need for systems and methods for decreasing the likelihood of user collisions in virtual reality environments and for increasing the number of users that can engage in a virtual reality environment of a given physical environment.

### BRIEF SUMMARY OF THE INVENTION

To meet the needs described above and others, the present disclosure provides systems and methods for generating a virtual reality environment in which first and second users' relative positioning and movement in a physical environment corresponds to different relative positioning and movement in the virtual reality environment. For example, where the positioning of first and second users in the physical environment is distanced, the corresponding positioning in the virtual environment is close together. The systems and methods are implemented through the design of a virtual environment, tracking at least two user's movements in the physical environment, and representing the at least two user's movements according to at least two different mapping schemes within the virtual environment.

For purposes of this disclosure, VR systems are understood to be a combination of one or more devices through which a VR environment may be displayed to a user and with which the user may explore and interact. Of particular relevance are multi-user VR environments in which multiple users interact within a single VR environment and, even more relevant, instances in which multi-user VR environments are provided in which two or more of the users are located within the same physical environment. These devices used within the VR system may include, but are not limited to, head-mounted displays (HMDs), wearable computing systems, server or cloud-based computing systems, tracking systems (e.g., laser based, camera based, etc.), motion controllers, handheld controllers, and any other such device that aids in user tracking and virtual immersion, as will be recognized by one having ordinary skill in the art with respect to the subject matter presented herein.

VR environments can be constructed to match, on a one-to-one basis, the physical environment in which the user will be located when interacting with the VR environment (dimensions, elevations, etc.). In the systems and methods described herein, the VR systems utilize distinct mapping schemes so that a first VR hardware in the physical environment is mapped to the virtual reality environment according to one orientation while a second VR hardware in the physical environment is mapped to the virtual reality environment according to second orientation. Generally, a mapping scheme maps a set of coordinates defining the physical environment to a set of coordinates defining the virtual reality environment. When using multiple mapping schemes, a first mapping scheme maps a first set of coordinates defining the physical environment to a set of coordinates defining the virtual reality environment while a second mapping scheme maps a second set of coordinates defining the physical environment to a set of coordinates defining the virtual reality environment. Use of distinct mapping schemes reduces the likelihood of collision in the physical space when users are interacting within close range in the virtual reality environment.

The virtual reality system of the present application includes first and second user devices, a user location tracking system, and a processor. The processor is programmed to generate and present a virtual reality environment to each of the first and second user devices. The processor also tracks the movement of the user virtual reality devices in the physical environment via the user location tracking system and represents the corresponding movement in the virtual reality environment.

Each of the first and second devices is oriented within the virtual reality environment according to different mapping schemes. The mapping scheme is the positioning of the VR hardware in the virtual reality environment relative to the positioning of the VR hardware in the physical environment. First and second users wearing VR devices stand in the physical environment while being represented by first and second avatars within the VR environment, but the VR devices are oriented according to different mapping schemes such that the spacing of the avatars in the virtual reality environment is different than the spacing of the users in the physical environment.

For example, first and second users walk on the floor of the physical environment. A first user virtual reality device is mapped to the physical environment in a first orientation or first X, Y plane corresponding to the floor. A second user virtual reality device is mapped to the floor in a second orientation or a second X, Y plane corresponding to the floor. The second X, Y plane is offset from the first X, Y plane by a degree of rotation, each plane aligned at a Z-axis. During the virtual reality game, the virtual reality environment includes a playable space corresponding to the first and second X, Y planes overlapped with one another and aligned along the X- and Y-axes.

In one example, the second X, Y plane is mapped to the floor of the physical environment at a 180 degree offset from the first X, Y plane. When the first and second users stand at approximately the same position in the physical space, the first and second user avatars appear in opposing quadrants within the virtual reality environment. Similarly, the first and second user avatars appear next to one another in the virtual environment when the first and second users are positioned approximately 180 degrees apart in the physical environment.

As the game is played, avatars interact with one another in the virtual environment in a variety of ways. In a game where users are divided into separate teams, the first and second mapping schemes may be used for first and second teams, respectively. For example, during a virtual reality game, players on opposite teams may approach one another around a series of corners or hallways. The players may be walking slowly next to one another in the virtual environment, but due to the use of unique mapping schemes, are in separate quadrants in the physical space so as to avoid real-life physical collisions. By utilizing two different mapping schemes in a virtual reality environment as users explore the associated physical environment, a greater number of players may engage in the game with a lower risk of collision.

Separate mapping schemes also allows for the virtual reality system to generate multiple virtual reality environments based on a single physical environment, enabling a greater number of players to play at a time. For example, a first pair of teams uses a first mapping scheme having a first X, Y plane orientation while a second pair of teams uses a second mapping scheme having a second X, Y plane orientation rotated 180 degrees about the Z-axis relative to the first X, Y plane.

The degree of rotation may be adjusted to accommodate different numbers of teams. For example, three teams may use the same space with a 120 degree of rotation. The second team uses a second mapping scheme having a second X, Y plane rotated 120 degrees relative to the first X, Y plane of the first mapping scheme of the first team. The third team's mapping scheme includes a third X, Y plane rotated 240 degrees relative to the first X, Y plane. Similarly, four teams may use the same space with a 90 degree of rotation relative to one another.

The following method may be used to generate a virtual reality environment utilizing first and second mapping schemes for a corresponding physical environment. First, a first mapping scheme corresponding to the physical environment having a first X, Y plane transverse to a Z-axis is identified or provided. A second mapping scheme corresponding to the physical environment having a second X, Y plane along the Z-axis is then identified or provided. In one embodiment, the processor identifies the first and second X, Y planes, while in other embodiments, the first and second X, Y planes are provided to the processor by a remote server, a further processor, or a database. In both embodiments, the second X, Y plane is offset from the first X, Y plane by a degree of rotation. The processor then overlaps the first and second X, Y planes and rotates the second plane relative to the first plane by the degree of rotation in order to align the X- and Y-axes. The process generates a playable space in the virtual reality environment featuring the aligned first and second X, Y planes. The virtual reality environment is provided to first and second user virtual reality devices, each of which are associated with the first and second mapping schemes, respectively, such that the first and second users interact in the playable space in the virtual reality environment.

In another embodiment, the processor may determine the degree of rotation based on the physical limitations within the physical environment. In this method, the processor receives or identifies a first plurality or layout of structures on the floor of the physical environment. The processor then defines a first X, Y plane in a first mapping scheme, wherein the first X, Y plane corresponds to the floor of the physical environment. The processor then maps the layout of structures onto the first X, Y plane. A second X, Y plane of a second mapping scheme is then defined, with the second X, Y plane corresponding to the floor of the physical environment as well. The first X, Y plane and the second X, Y plane are aligned along a Z-axis and not aligned along the X-axis or Y-axis. The processor then maps the layout of structures onto the second X, Y plane. The processor then identifies a degree of rotation between the first X, Y plane and the second X, Y plane that maximizes overlap of the layout of structures mapped onto the first X, Y plane with the layout of structures mapped onto the second X, Y plane, wherein the degree of rotation must be equal to or greater than about 30 degrees and less than or equal to about 330 degrees. The goal is to maximize the amount of overlap between the first and second pluralities of structures, thereby maximizing the common playable space in the virtual reality environment. A playable space is generated by overlapping the first and second X, Y planes and aligning the X- and Y-axes. The system displays the virtual reality environment in the first and second user virtual reality devices, worn by first and second users respectively, and which are mapped to the physical environment via the first and second mapping schemes, respectively. The system displays first and second user avatars in the virtual reality environment according to the first and second mapping schemes, respectively.

In one embodiment, a virtual reality system for presenting a virtual reality environment to first and second users is provided. The virtual reality environment has an associated physical environment. The virtual reality system includes a first user virtual reality device associated with a first mapping scheme, a second user virtual reality device associated with a second mapping scheme, a user location tracking system that tracks the first user virtual reality device and the second user virtual reality device in the physical environment, a processor in communication with the first user virtual reality device, the second user virtual reality device, and the user location tracking system, and a memory in communication with the processor. The first mapping scheme maps a first set of coordinates defining the physical environment to a set of coordinates defining the virtual reality environment, and the second mapping scheme maps a second set of coordinates defining the physical environment to the set of coordinates defining the virtual reality environment. The first mapping scheme is different than the second mapping scheme. The memory stores program instructions that, when executed by the processor, cause the processor to: present the virtual reality environment to the first and second users through each of the first user virtual reality device and the second user virtual reality device, respectively; track movement, through the user location tracking system, of the first virtual reality device within the physical environment; present movement of the first user in the virtual reality environment according to the first mapping scheme; track movement, through the user location tracking system, of the second virtual reality device within the physical environment; and present movement of the second user in the virtual reality environment according to the second mapping scheme.

In some embodiments, the first mapping scheme defines a first X, Y plane that is different than a second X, Y plane defined by the second mapping scheme. The first X, Y plane and the second X, Y plane may be aligned along a Z-axis, and the second X, Y plane may be offset from the first X, Y plane by a degree of rotation. In some embodiments, the second X, Y plane is offset from the first X, Y plane by 180 degrees about the Z-axis.

In another embodiment, the virtual reality system further includes a third user virtual reality device associated with a third mapping scheme, wherein the third mapping scheme maps a third set of coordinates defining the physical environment to a set of coordinates defining the virtual reality environment. The third mapping scheme is different than the first mapping scheme and the second mapping scheme. The processor is further configured to: present the virtual reality environment to the third user through the third user virtual reality; track movement of the third virtual reality device within the physical environment; and present movement of the third user in the virtual reality environment according to the third mapping scheme.

In some embodiments, the third mapping scheme defines a third X, Y plane that is different than the first X, Y plane and the second X, Y plane. The first X, Y plane, the second X, Y plane, and the third X, Y plane are aligned along a Z-axis. The second X, Y plane is offset from the first X, Y plane by 120 degrees about the Z-axis, and the third X, Y plane is offset from the first X, Y plane by 240 degrees about the Z-axis.

In another embodiment, a virtual reality system presents a first virtual reality environment and a second virtual reality environment to first and second users, respectively. The first and second virtual reality environments have an associated physical environment, and the virtual reality system includes a first user virtual reality device associated with a first mapping scheme, a second user virtual reality device associated with a second mapping scheme, a user location tracking system that tracks the first user virtual reality device and the second user virtual reality device in the physical environment, a processor in communication with the first user virtual reality device, the second user virtual reality device, and the user location tracking system, and a memory in communication with the processor. The first mapping scheme maps a first set of coordinates defining the physical environment to a set of coordinates defining the first virtual reality environment, and the second mapping scheme maps a second set of coordinates defining the physical environment to the set of coordinates defining the second virtual reality environment. The memory stores program instructions that, when executed by the processor, cause the processor to: present the first virtual reality environment to the first user through the first user virtual reality device; present the second virtual reality environment to the second user through the second user virtual reality device; track movement, through the user location tracking system, of the first virtual reality device within the physical environment; present movement of the first user in the first virtual reality environment according to the first mapping scheme; track movement, through the user location tracking system, of the second virtual reality device within the physical environment; and present movement of the second user in the second virtual reality environment according to the second mapping scheme.

In a still further embodiment, a method of presenting a virtual reality environment to first and second users is provided. The virtual reality environment has an associated physical environment, and the method includes the steps of: mapping a first user virtual reality device to the physical environment according to a first mapping scheme, wherein the first mapping scheme maps a first set of coordinates defining the physical environment to a set of coordinates defining the virtual reality environment; mapping a second user virtual reality device to the physical environment according to a second mapping scheme, wherein the second mapping scheme maps a second set of coordinates defining the physical environment to a set of coordinates defining the virtual reality environment, wherein the first mapping scheme is different than the second mapping scheme; tracking, through a user location tracking system, movement of the first user virtual reality device and the second user virtual reality device in the physical environment; presenting the virtual reality environment to the first and second users through each of the first user virtual reality device and the second user virtual reality device, respectively; presenting movement of the first user in the virtual reality environment according to the first mapping scheme; and presenting movement of the second user in the virtual reality environment according to the second mapping scheme.

Any of the features, functionality, and alternatives described in connection with one of the embodiments described herein may be combined with any of the features, functionality, and alternatives described with respect to other embodiments.

An object of the invention is to provide a solution to decrease the risk of collisions between users in a multi-user VR environment to break the one-to-one ratio between the VR environment and the physical environment through which the users move.

Another object of the invention is to promote a greater sense of security to the user to foster the user's ability to immerse himself or herself in the VR experience.

An advantage of the solutions provided herein is that they enable the safe expansion of the VR environment beyond the limits of the users' physical environment.

Another advantage of the solutions provided herein is that they are effective while being minimally invasive to the VR experience.

Additional objects, advantages, and novel features of the solutions provided herein will be recognized by those skilled in the art based on the following detail description and claims, as well as the accompanying drawings, and/or may be learned by production or operation of the examples provided herein.

### BRIEF DESCRIPTION OF THE DRAWINGS

The figures depict one or more embodiments of the subject matter described herein. They are provided as examples only. Within the figures, reference numbers are used to refer to elements described in the detailed description.

FIG. 1 is a schematic diagram illustrating example components of a virtual reality system utilizing distinct mapping schemes.

FIGS. 2A and 2B illustrate the virtual reality environment and the corresponding physical environment of the virtual reality system of FIG. 1.

FIGS. 3A and 3B illustrate exemplary first and second mapping schemes used in the virtual reality system of FIG. 1.

FIG. 4 is flow chart representing an example of a method for presenting a virtual reality environment to first and second users in virtual reality environments.

FIG. 5 is flow chart representing a further example of a method for presenting a virtual reality environment to first and second users in virtual reality environments.

### DETAILED DESCRIPTION OF THE INVENTION

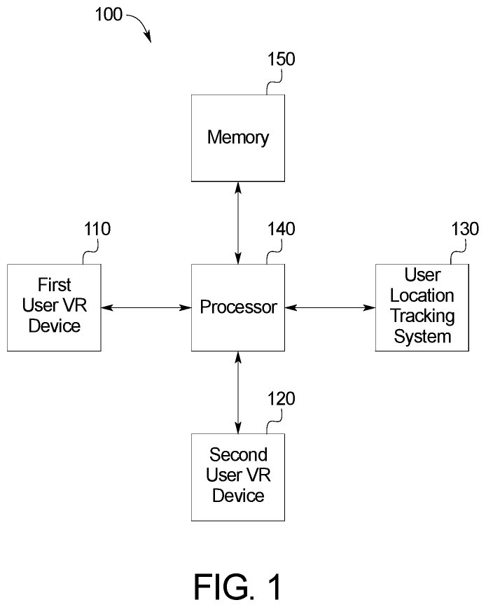

FIG. 1 illustrates a virtual reality system utilizing distinct mapping schemes. Specifically, the system 100 is useful for increasing the number of users that may occupy a physical space while engaging in a virtual reality environment, meaning that a greater number of players may participate in a VR game in a given space. The system enables first and second users to explore the physical environment while their respective VR hardware is mapped to the corresponding virtual environment according to different mapping schemes.

In the embodiment illustrated in FIG. 1, the system 100 includes a first user virtual reality device 110 (e.g., an HMD), a second user virtual reality device 120 (e.g., an HMD), a user location tracking system 130 (e.g., an ultra-wideband signal and reflective marker system in which ultra-wideband signal transceivers read the locations of users based on reflections from reflective markers worn or carried by the users), a processor 140 in communication with each of the first user virtual reality device 110, the second user virtual reality device 120, and the user location tracking system 130, and a memory 150 in communication with the processor 140. The memory 150 stores program instructions that, when executed by the processor 140, cause the processor 140 to perform the features and functions described herein.

The processor 140 presents a virtual reality environment to each of the first and second user virtual reality devices 110, 120. The first and second users explore the corresponding physical environment while the corresponding first and second user avatars appear in a playable space of the virtual reality environment, with the first and second users' relative movement in the physical environment corresponding to different relative movement in the virtual reality environment.

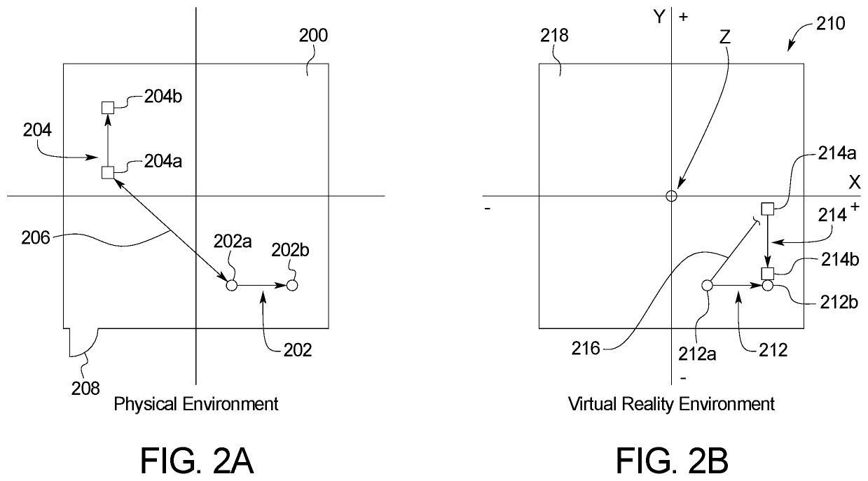

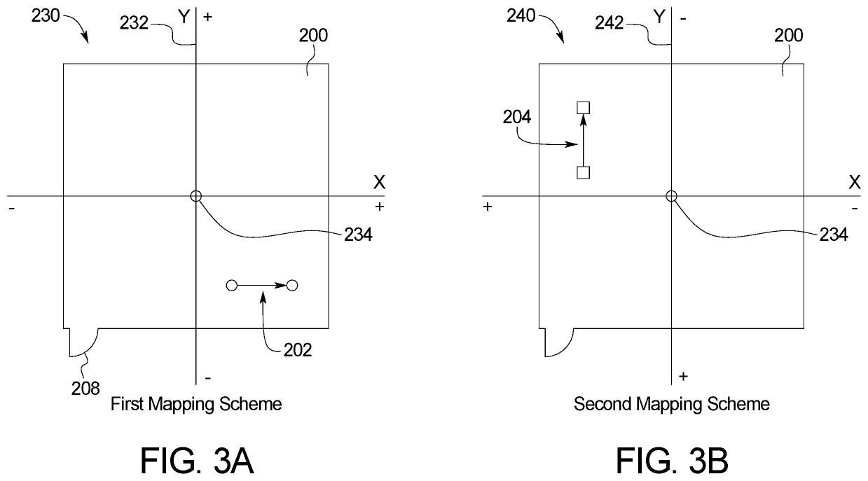

A mapping scheme refers to positioning of the VR hardware in the virtual reality environment relative to the positioning of the VR hardware in the physical environment. Each of the first and second virtual reality devices 110, 120 are oriented within the virtual reality environment according to different mapping schemes. Referring to FIGS. 2A and 2B, positioning and movements of the first and second users 202, 204 in the physical environment 200 are shown in FIG. 2A while the positioning and movements of the first and second user avatars 212, 214 within the VR environment 210 are shown in FIG. 2B. The spacing 206, 216 is different because the VR devices 110, 120 are oriented according to different mapping schemes. FIGS. 3A and 3B illustrate the first and second mapping schemes 230, 240, respectively.

Generally, a mapping scheme maps a set of coordinates defining the physical environment to a set of coordinates defining the virtual reality environment. When using multiple mapping schemes, a first mapping scheme maps a first set of coordinates defining the physical environment to a set of coordinates defining the virtual reality environment while a second mapping scheme maps a second set of coordinates defining the physical environment to a set of coordinates defining the virtual reality environment.

In FIG. 3A, a first mapping scheme 230 orients a first X, Y plane 232 on a Z-axis 234 on the physical environment 200. The door 208 of the physical environment 200 is located in the (-x, -y) quadrant of the first X, Y plane 232. FIG. 3B illustrates a second mapping scheme 240 in which the second X, Y plane 242 is oriented in the physical environment 200. In the second X, Y plane 242, the door 208 is located in the (+x, +y) quadrant. The door 208 is an element of the physical environment 200 and not the virtual reality environment 210. The first and second users 212, 214 immersed in the virtual reality environment 210 are unaware of the positioning of the door 208 and are only aware of the avatars 212, 214 in the virtual reality environment 210 as shown in FIG. 2B.

Once the first and second mapping schemes 230, 240 of FIGS. 3A and 3B are identified, the processor 140 creates the playable space 218 of the virtual reality environment 210 shown in FIG. 2B. To create the playable space 218, the processor 140 overlaps the first and second X, Y planes 232, 242 of the first and second mapping schemes 230, 240 of FIGS. 3A and 3B and rotates the second X, Y plane 242 relative to the first X, Y plane 232 in order to align the X- and Y-axes about the Z-axis. The second X, Y plane 242 is therefore offset from the first X, Y plane 232 by a degree of rotation. In the illustrated embodiment, the second X, Y plane 242 is offset from the first X, Y plane 232 by 180 degrees of rotation.

The playable space 218 may include a protection zone at the center of the aligned first and second X, Y planes along the Z-axis. The protection zone is an area common to both the virtual reality environment(s) and the associated physical environment in which users are prevented from entering in order to minimize collisions. For example, the protection zone may be an area defined by a 6-foot radius about the Z-axis. The virtual reality environment(s) may include virtual features such as a building or a fire that prevents users from accessing the protection zone during the game play. The physical environment may include a fence or other physical structure to prevent users from entering the protection zone. The size and/or dimensions of the protection zone may vary depending on the number of players in the physical environment, the size of the physical environment, the number of mapping schemes utilizing the physical environment, and/or other additional factors.

FIGS. 2A-3B also illustrate movement of the first and second users 202, 204 from initial positions to final positions. In the physical environment 200 of FIG. 2A, the first and second users 202, 204 move within quadrants located diagonal from one another. Simultaneously, the first and second user avatars 212, 214 fully immersed in the game interact closely within the same quadrant in the virtual reality environment 210 as shown in FIG. 2B. The first user's physical initial and final positions 202a, 202b correspond to his virtual initial and final positions 212a, 212b, while the second user avatar's virtual initial and final positions 214a, 214b are represented in the virtual reality environment 210 at 180 degrees from his physical initial and final positions 204a, 204b.

During use, the processor 140 provides the first user avatar 212 visible to the second user 204 in the virtual reality environment 210 via the second user virtual reality device 120 and a second user avatar 214 visible to the first user 202 in the virtual reality environment 210 via the first user virtual reality device 110. The first and second user avatars 212, 214 are positioned within the virtual reality environment 210 in accordance with the respective mapping schemes 230, 240 relating the first and second users 202, 204 within the physical space 200 to the virtual reality environment 210.

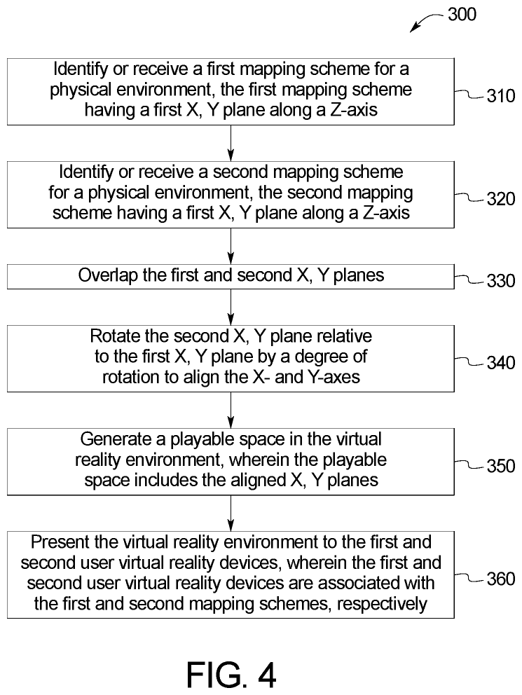

Referring to FIG. 4, the following method 300 may be used to generate a virtual reality environment utilizing first and second mapping schemes for a corresponding physical environment. In the first step 310, a first mapping scheme corresponding to the physical environment having a first X, Y plane transverse to a Z-axis is identified. A second mapping scheme corresponding to the physical environment having a second X, Y plane along the Z-axis is identified in the second step 320. The first and second X, Y planes align at the Z-axis and are offset by a degree of rotation. The degree of rotation may be selected based on the number of players or based on the ratio of users to space within the physical environment. In other embodiments, the degree of rotation may be randomly selected. Further, the processor may identify the first and second X, Y planes based on a stored map of the physical environment. In another embodiment, the processor receives the first and second mapping schemes including the respective first and second X, Y planes from a remote server or other processor.

In the third through fifth steps 330, 340, 350, the processor overlaps the first and second X, Y planes, rotates the second X, Y plane relative to the first X, Y plane, and aligns the X- and Y-axes to generate a playable space in the virtual reality environment.

The virtual reality is provided to first and second user virtual reality devices in the sixth step 360. As described above, the first and second user virtual reality devices are associated with the first and second mapping schemes, respectively. The first and second users interact in the virtual reality environment while exploring the physical environment.

In another embodiment, the processor may provide distinct first and second virtual reality environments to the first and second virtual reality user devices. A first mapping scheme corresponding to the physical environment having a first X, Y plane transverse to a Z-axis is identified, and a second mapping scheme corresponding to the physical environment having a second X, Y plane along the Z-axis is identified. Each of the first and second mapping schemes maps first and second sets of coordinates, respectively, defining the physical environment to sets of coordinates defining the first and second virtual reality environments, respectively. The first and second virtual reality user devices are associated with the first and second mapping schemes, respectively.

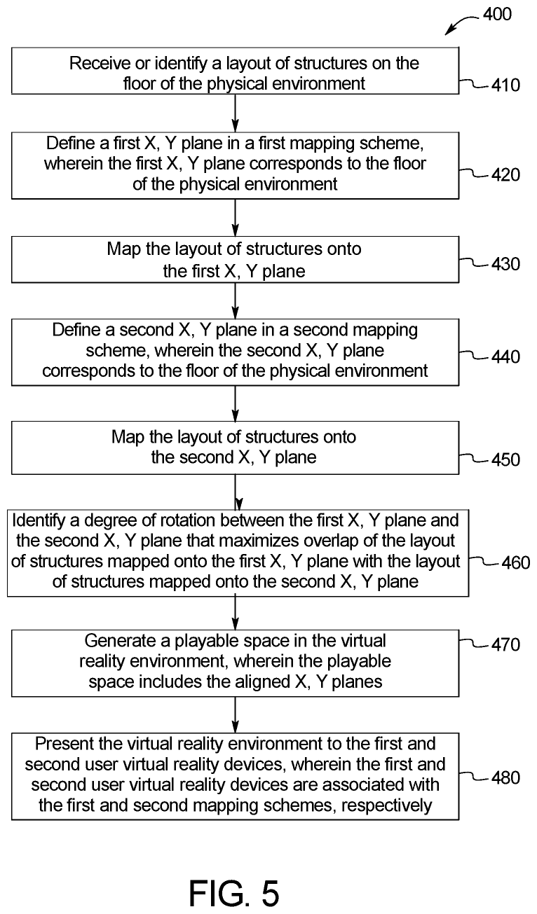

Referring to FIG. 5, the virtual reality system may determine a degree of rotation based on physical limitations within the physical environment. For example, an arena may be a predominantly open space with a few structures such as support columns, partial walls, piping extending from the walls, tables or other furniture secured to the floor, or the like. In this embodiment, the virtual reality system rotates the second X, Y plane relative to the first X, Y plane in order to optimize the overlapping of physical limitations in the X, Y planes, thereby maximizing the playable space of the virtual reality environment.

In this embodiment, the following method 400 may be used to generate a virtual reality environment utilizing first and second mapping schemes based on physical limitations for a corresponding physical environment. The processor receives or identifies a first plurality or layout of structures on the floor of the physical environment in the first step 410. The processor then defines a first X, Y plane in a first mapping scheme, wherein the first X, Y plane corresponds to the floor of the physical environment in the second step 420. The processor may identify the first X, Y plane and layout of structures based on a stored map of the physical environment or may receive the first X, Y plane and plurality of structures from a database, server, or other processor. The processor then maps the layout of structures onto the first X, Y plane in step 430.

In the next step 440, the processor defines a second X, Y plane of a second mapping scheme, with the second X, Y plane corresponding to the floor of the physical environment as well. The first X, Y plane and the second X, Y plane are aligned along a Z-axis and not aligned along the X-axis or Y-axis. The processor then maps the layout of structures onto the second X, Y plane in step 450.

In step 460, the processor identifies a degree of rotation between the first X, Y plane and the second X, Y plane that maximizes overlap of the layout of structures mapped onto the first X, Y plane with the layout of structures mapped onto the second X, Y plane. The goal is to maximize the amount of overlap between the first and second pluralities of structures, thereby maximizing the common playable space in the virtual reality environment. In some embodiments, the degree of rotation must be equal to or greater than about 30 degrees and less than or equal to about 330 degrees.

A playable space is then generated by overlapping the first and second X, Y planes and aligning the X- and Y-axes in step 470. In a preferred embodiment, the playable space includes a rotational offset between about 30 to about 330 degrees in combination with a protection zone having a 6-foot radius. The system then displays the virtual reality environment in the first and second user virtual reality devices, worn by first and second users respectively, and which are mapped to the physical environment via the first and second mapping schemes, respectively, in step 480. The system displays first and second user avatars in the virtual reality environment according to the first and second mapping schemes, respectively.

It should be noted that various changes and modifications to the presently preferred embodiments described herein will be apparent to those skilled in the art. Such changes and modifications may be made without departing from the spirit and scope of the present invention and without diminishing its attendant advantages.

1. A virtual reality system for presenting a virtual reality environment to first and second users, wherein the virtual reality environment has an associated physical environment, the virtual reality system comprising:
a first user virtual reality device associated with a first mapping scheme, wherein the first mapping scheme maps a first set of coordinates defining the physical environment to a set of coordinates defining the virtual reality environment;
a second user virtual reality device associated with a second mapping scheme, wherein the second mapping scheme maps a second set of coordinates defining the physical environment to the set of coordinates defining the virtual reality environment, wherein the first mapping scheme is different than the second mapping scheme;
a user location tracking system that tracks the first user virtual reality device and the second user virtual reality device in the physical environment;
a processor in communication with the first user virtual reality device, the second user virtual reality device, and the user location tracking system; and
a memory in communication with the processor, the memory storing program instructions that, when executed by the processor, cause the processor to:
present the virtual reality environment to the first and second users through each of the first user virtual reality device and the second user virtual reality device, respectively;
track movement, through the user location tracking system, of the first virtual reality device within the physical environment;
present movement of the first user in the virtual reality environment according to the first mapping scheme;
track movement, through the user location tracking system, of the second virtual reality device within the physical environment; and
present movement of the second user in the virtual reality environment according to the second mapping scheme.

2. The virtual reality system of claim 1, wherein the first mapping scheme defines a first X, Y plane that is different than a second X, Y plane defined by the second mapping scheme.

3. The virtual reality system of claim 2, wherein the first X, Y plane and the second X, Y plane are aligned along a Z-axis.

4. The virtual reality system of claim 3, wherein the second X, Y plane is offset from the first X, Y plane by a degree of rotation.

5. The virtual reality system of claim 4, wherein the second X, Y plane is offset from the first X, Y plane by 180 degrees about the Z-axis.

6. The virtual reality system of claim 1, further comprising a third user virtual reality device associated with a third mapping scheme, wherein the third mapping scheme maps a third set of coordinates defining the physical environment to a set of coordinates defining the virtual reality environment, wherein the third mapping scheme is different than the first mapping scheme and the second mapping scheme; and wherein the processor is configured to:
present the virtual reality environment to the third user through the third user virtual reality;
track movement of the third virtual reality device within the physical environment; and
present movement of the third user in the virtual reality environment according to the third mapping scheme.

7. The virtual reality system of claim 6, wherein the third mapping scheme defines a third X, Y plane that is different than the first X, Y plane and the second X, Y plane;
wherein the first X, Y plane, the second X, Y plane, and the third X, Y plane are aligned along a Z-axis;
wherein the second X, Y plane is offset from the first X, Y plane by 120 degrees about the Z-axis; and
wherein the third X, Y plane is offset from the first X, Y plane by 240 degrees about the Z-axis.

8. The virtual reality system of claim 1, wherein the processor is further configured to:
receive a layout of structures on a floor within the physical environment;
define a first X, Y plane in the first mapping scheme, wherein the first X, Y plane corresponds to the floor of the physical environment;
map the layout of structures onto the first X, Y plane;
define a second X, Y plane in the second mapping scheme, wherein the second X, Y plane corresponds to the floor of the physical environment, and wherein the first X, Y plane and the second X, Y plane are aligned along a Z-axis and not aligned along the X-axis or Y-axis;
map the layout of structures onto the second X, Y plane;
identify a degree of rotation between the first X, Y plane and the second X, Y plane that maximizes overlap of the layout of structures mapped onto the first X, Y plane with the layout of structures mapped onto the second X, Y plane, wherein the degree of rotation must be equal to or greater than about 30 degrees and less than or equal to about 330 degrees; and
rotationally offset the second X, Y plane from the first X, Y plane by the identified degree of rotation.

9. A virtual reality system for presenting a first virtual reality environment and a second virtual reality environment to first and second users, respectively, wherein the first and second virtual reality environments have an associated physical environment, the virtual reality system comprising:
a first user virtual reality device associated with a first mapping scheme, wherein the first mapping scheme maps a first set of coordinates defining the physical environment to a set of coordinates defining the virtual reality environment;
a second user virtual reality device associated with a second mapping scheme, wherein the second mapping scheme maps a second set of coordinates defining the physical environment to the set of coordinates defining the virtual reality environment;
a user location tracking system that tracks the first user virtual reality device and the second user virtual reality device in the physical environment;
a processor in communication with the first user virtual reality device, the second user virtual reality device, and the user location tracking system; and
a memory in communication with the processor, the memory storing program instructions that, when executed by the processor, cause the processor to:
present the first virtual reality environment to the first user through the first user virtual reality device;
present the second virtual reality environment to the second user through the second user virtual reality device;
track movement, through the user location tracking system, of the first virtual reality device within the physical environment;
present movement of the first user in the first virtual reality environment according to the first mapping scheme;
track movement, through the user location tracking system, of the second virtual reality device within the physical environment; and
present movement of the second user in the second virtual reality environment according to the second mapping scheme.

10. The virtual reality system of claim 9, wherein the first mapping scheme defines a first X, Y plane that is different than a second X, Y plane defined by the second mapping scheme.

11. The virtual reality system of claim 10, wherein the first X, Y plane and the second X, Y plane are aligned along a Z-axis.

12. The virtual reality system of claim 11, wherein the second X, Y plane is offset from the first X, Y plane by a degree of rotation.

13. A method of presenting a virtual reality environment to first and second users, wherein the virtual reality environment has an associated physical environment, the method comprising:
mapping a first user virtual reality device to the physical environment according to a first mapping scheme, wherein the first mapping scheme maps a first set of coordinates defining the physical environment to a set of coordinates defining the virtual reality environment;
mapping a second user virtual reality device to the physical environment according to a second mapping scheme, wherein the second mapping scheme maps a second set of coordinates defining the physical environment to a set of coordinates defining the virtual reality environment;
tracking, through a user location tracking system, movement of the first user virtual reality device and the second user virtual reality device in the physical environment;
presenting the virtual reality environment to the first and second users through each of the first user virtual reality device and the second user virtual reality device, respectively;
presenting movement of the first user in the virtual reality environment according to the first mapping scheme; and
presenting movement of the second user in the virtual reality environment according to the second mapping scheme.

14. The method of claim 13, wherein the first mapping scheme defines a first X, Y plane that is different than a second X, Y plane defined by the second mapping scheme.

15. The method of claim 14, wherein the first X, Y plane and the second X, Y plane are aligned along a Z-axis.

16. The method of claim 15, wherein the second X, Y plane is offset from the first X, Y plane by a degree of rotation.

17. The method of claim 13, wherein the first mapping scheme maps a first set of coordinates defining the physical environment to a set of coordinates defining a first virtual reality environment;
wherein the second mapping scheme maps a second set of coordinates defining the physical environment to a set of coordinates defining a second virtual reality environment;
wherein the step of presenting the virtual reality environment to the first and second users comprises the steps of:
presenting the first virtual reality environment associated with the physical environment to the first user through the first user virtual reality device; and
presenting the second virtual reality environment associated with the physical environment to the second user through the second user virtual reality device.

18. The method of claim 13, further comprising the steps of:
receiving a layout of structures on a floor within the physical environment;
defining a first X, Y plane in the first mapping scheme, wherein the first X, Y plane corresponds to the floor of the physical environment;
mapping the layout of structures onto the first X, Y plane;
defining a second X, Y plane in the second mapping scheme, wherein the first X, Y plane and the second X, Y plane are aligned along a Z-axis and not aligned along the X-axis or Y-axis;
mapping the layout of structures onto the second X, Y plane;
identifying a degree of rotation between the first X, Y plane and the second X, Y plane that maximizes overlap of the layout of structures mapped onto the first X, Y plane with the layout of structures mapped onto the second X, Y plane, wherein the degree of rotation must be equal to or greater than about 30 degrees and less than or equal to about 330 degrees; and
rotationally offsetting the second X, Y plane from the first X, Y plane by the identified degree of rotation.
